(19) United States
(12) Patent Application Publication
(10) Pub. No.: US 2026/0333083 A1
(43) Pub. Date: Oct. 22, 2026

(54) METHOD AND APPARATUS OF SUPPORTING QUALITY OF EXPERIENCE (QoE) PREDICTION

(71) Applicant: LENOVO (BEIJING) LIMITED, Beijing (CN)

(72) Inventors: Shuigen Yang, Shanghai (CN); Mingzeng Dai, Shanghai (CN); Congchi Zhang, Shanghai (CN)

(21) Appl. No.: 19/109,640

(22) PCT Filed: Sep. 9, 2022
(86) PCT No.: PCT/CN2022/118154

§ 371 Date: Mar. 7, 2025

(51) Int. Cl. H04W 24/08; H04W 24/10

(52) U.S. Cl. CPC H04W 24/08; H04W 24/10

(57) ABSTRACT

A method and an apparatus of supporting quality of experience (QoE) prediction are disclosed. The method may include: transmitting first information at least indicating one or more QoE metrics to a node, wherein the first information is a QoE history information request or QoE prediction configuration information; and receiving second information at least indicating the one or more QoE metrics and values of the one or more QoE metrics, wherein the second information is a QoE history information report in response to the QoE history information request or a QoE prediction information report in response to the QoE prediction configuration information.

### TECHNICAL FIELD

Embodiments of the present application are related to wireless communication technology, especially, related to artificial intelligence (AI) application in wireless communication, e.g., a method and apparatus of supporting quality of experience (QoE) prediction.

### BACKGROUND OF THE INVENTION

AI, at least including machine learning (ML) is used to learn and perform certain tasks via training neural networks (NNs) with vast amounts of data, which is successfully applied in computer vison (CV) and nature language processing (NLP) areas. Deep learning (DL), which is a subordinate concept of ML, utilizes multi-layered NNs as an “AI model” (or AI algorithm) to learn how to solve problems and/or optimize performance from vast amounts of data.

By leveraging the advantage of AI, the performance of radio access network (RAN) network can be further optimized in at least the following use cases: energy saving, load balancing, traffic steering and mobility optimization. Thus, 3rd generation partnership program (3GPP) has been considering to introduce AI into 3GPP since 2016, including several study items and work items in SA1, SA2, SA5 and RAN3.

Taking QoE as an example, in 3GPP release (Rel)-17, the basic mechanism for new radio (NR) QoE has been specified. However, for the highly demanding 5G traffic-intensive and interactive applications like virtual reality (VR), current semi-static quality of service (QoS) framework cannot satisfy diversified QoE requirements because it does not take into account potentially significant fluctuation of radio transmission capability. It is expected that AI assisted QoE optimization, e.g., AI assisted QoE prediction (and/or estimation) from application layer can help deal with such uncertainty and improve the user experience by QoE aware optimizations, such as QE aware scheduling, QoE aware resource allocation, QoE aware mobility, and QoE aware dual connectivity (DC) configuration.

Therefore, the industry needs a technical solution of QoE optimization, which is based on AI models (or AI algorithms) from the network side or remote side and will improve resource optimization and AI application in RAN.

### SUMMARY

One objective of the embodiments of the present application is to provide a technical solution for wireless communication, especially a technical solution of supporting QoE prediction based on AI models.

Some embodiments of the present application provide a wireless communication apparatus, e.g., a RAN node or a core network (CN) node or other network node, which includes: a transceiver; and a processor coupled to the transceiver, wherein the processor is configured to: transmit first information at least indicating one or more QoE metrics to a node, wherein the first information is a QoE history information request or QoE prediction configuration information; and receive second information at least indicating the one or more QoE metrics and values of the one or more QoE metrics, wherein the second information is a QoE history information report in response to the QoE history information request or a QoE prediction information report in response to the QoE prediction configuration information.

In some embodiments of the present application, the one or more QoE metrics include at least one of the following metrics: quality level of service, which is measured by performance of subjective tests between two nodes; application layer buffer level, which indicates a buffer level of application layer; initial playout delay, which indicates an initial playout delay of application layer; corruption duration, which indicates a time period from time of a last uncorrupted frame before corruption to time of a first subsequent uncorrupted frame after the corruption; rendered viewports, which indicates a list of viewports that have been rendered during media presentation; play period, which indicates a time interval between a user action and whichever occurs soonest among a next user action, end of playback or a failure that stops playback; or comparable quality viewport switching latency, which indicates latency and quality-related factors when viewport movement causes quality degradation. An example of the quality level of service is mean opinion score (MOS), which provides a numerical indication of perceived quality from user's perspective of received service.

In some embodiments of the present application, the QoE history information request further indicates at least one of the following parameters: an indicator which indicates whether the QoE history information needs to be reported; a service type which indicates a type of the QoE history information to be collected; an area scope which indicates at least one object for which the QoE history information is required; a trigger condition which indicates criteria of triggering QoE history information reporting; or time information which indicates latest time that the QoE history information is expected to be received.

In some embodiments of the present application, the QoE history information includes one or more entries of QoE measurement results, and each entry includes at least one of the following parameters besides the one or more QoE metrics and the values of the one or more QoE metrics within a configured valid area for a service type: start time and end time of QoE measurement indicated by application layer; a visited cell list of user equipment (UE) and duration of UE stay in each visited cell during the QoE measurement is performed; a radio condition at timing that the values of the one or more QoE metrics are received from upper layer; or a time stamp that the values of the one or more QoE metrics are received from upper layer.

In some embodiments of the present application, the QoE prediction configuration information further indicates at least one of the following parameters: an indicator which indicates whether QoE prediction information needs to be reported; time information which indicates latest time that QoE prediction information is expected to be received; an analytics period which indicates a time interval in the future that QoE prediction information will be located; a trigger condition which indicates criteria of triggering QoE prediction information reporting; a radio condition which indicates an environment under which QoE prediction information will be applied; or a preferred level of accuracy which indicates a preferred accuracy level of QoE prediction information.

In some embodiments of the present application, the QoE prediction information report further includes at least one of the following: an indicator which indicates whether QoE information report is predicted; a radio condition which indicates an environment under which QoE prediction information will be applied; a time stamp of analytics generation which indicates when QoE prediction information was generated; a validity period which indicates a time period for which QoE predication information is valid; or a confidence level which indicates probability assertion in QoE prediction.

In some embodiments of the present application, the wireless communication apparatus is a RAN node, the node is a UE, the first information is transmitted via a radio resource control (RRC) message, and the second information is received via another RRC message.

According to some embodiments of the present application, the RAN node is configured to further generate QoE prediction information based on the second information.

According to some other embodiments of the present application, the RAN node is configured to receive a QoE prediction capability report from the UE. For example, the RAN node is configured to transmit a QoE prediction capability request to the UE, and the QoE prediction capability report is received in response to the QoE prediction capability request. In another example, the QoE prediction configuration information is transmitted after receiving a QoE prediction capability report indicating that the UE is capable of predicting QoE.

According to some yet other embodiments of the present application, the first information is received from another RAN node, a CN node or an operation administration and maintenance (OAM) system.

According to some yet other embodiments of the present application, the second information is transmitted to another RAN node, a CN node or an OAM system. For example, the wireless communication apparatus is further configured to receive a QoE measurement report in response to the second information, from the other RAN node, the CN node or the OAM system.

In some embodiments of the present application, the wireless communication apparatus is a RAN node, a CN node or an OAM system, and the node is another RAN node.

According to some embodiments of the present application, the wireless communication apparatus is further configured to transmit a QoE measurement report to the other RAN node in response to the second information.

Some other embodiments of the present application provide a method of supporting QoE prediction, e.g., a method of supporting QoE prediction to be performed in a RAN node or a CN node or OAM system, which includes: transmitting first information at least indicating one or more QoE metrics to a node, wherein the first information is a QoE history information request or QoE prediction configuration information; and receiving second information at least indicating the one or more QoE metrics and values of the one or more QoE metrics, wherein the second information is a QoE history information report in response to the QoE history information request or a QoE prediction information report in response to the QoE prediction configuration information.

Some yet other embodiments of the present application provide a UE, which includes: a transceiver; and a processor coupled to the transceiver, wherein the processor is configured to: receive first information at least indicating one or more QoE metrics from a RAN node, wherein the first information is a QoE history information request or QoE prediction configuration information; and transmit second information at least indicating the one or more QoE metrics and values of the one or more QoE metrics, wherein the second information is a QoE history information report in response to the QoE history information request or a QoE prediction information report in response to the QoE prediction configuration information.

In some embodiments of the present application, the first information is received via a RRC message, and the second information is transmitted via another RRC message.

In some embodiments of the present application, the processor is configured to transmit a QoE prediction capability report to the RAN node. In an example, the QoE prediction capability report is transmitted in response to receiving a QoE prediction capability request from the RAN node. In another example, the QoE prediction configuration information is received after transmitting a QoE prediction capability report indicating that the UE is capable of predicting QoE.

In some embodiments of the present application, the processor is configured to generate QoE prediction information based on the QoE prediction configuration information.

Some yet other embodiments of the present application provide a method of supporting QoE prediction, e.g., a method of supporting QoE prediction to be performed in the remote side, which includes: receiving first information at least indicating one or more QoE metrics to a node, wherein the first information is a QoE history information request or QoE prediction configuration information; and transmitting second information at least indicating the one or more QoE metrics and values of the one or more QoE metrics, wherein the second information is a QoE history information report in response to the QoE history information request or a QoE prediction information report in response to the QoE prediction configuration information.

Given the above, embodiments of the present application propose a technical solution of supporting QoE prediction, wherein the QoE prediction can be based on an AI model in the network side or remote side, which will optimize user's QoE and facilitate the implementation of AI-based RAN.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 is a schematic diagram illustrating an exemplary wireless communication system according to some embodiments of the present application.

FIG. 2 illustrates a schematic diagram of a wireless communication system 200 in accordance with some other embodiments of the present application.

FIG. 3 is a schematic diagram illustrating an internal structure of a RAN node, e.g., a base station (BS) according to some embodiments of the present application.

FIG. 4 illustrates an exemplary procedure of a method of supporting QoE prediction according to some embodiments of the present application.

FIG. 5 illustrates another exemplary procedure of a method of supporting QoE prediction according to some other embodiments of the present application.

FIG. 6 illustrates a block diagram of an apparatus of supporting QoE prediction according to some embodiments of the present application.

FIG. 7 illustrates a block diagram of an apparatus of supporting QoE prediction according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long-term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a first UE 102a and a second UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a CN node (not shown), e.g., a mobility management entity (MME) or a serving gateway (S-GW), a mobility management function (AMF), or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g., during a handover procedure for a UE.

The UE 102, e.g., the first UE 102a and second UE 102b should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In a NR-DC scenario, a UE with multiple transceivers may be configured to utilize resources provided by two different nodes connected via non-ideal backhauls. Wherein one node may provide NR access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface, e.g., Xn interface as specified in 3GPP standard documents, and at least the MN is connected to the CN.

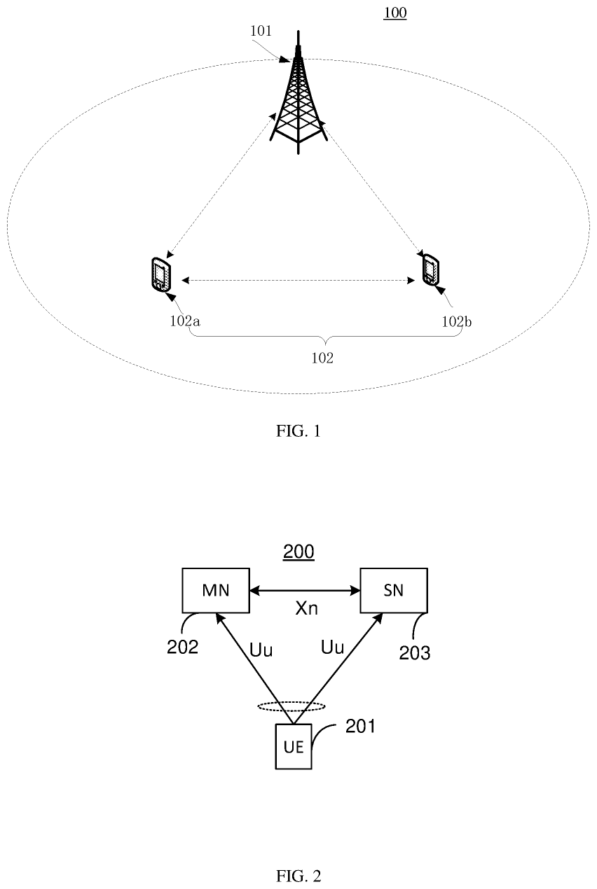

For example, FIG. 2 illustrates a schematic diagram of a wireless communication system 200 in accordance with some other embodiments of the present application.

As shown in FIG. 2, the wireless communication system 200 may be a dual connectivity system 200 includes at least one UE 201, at least one MN 202, and at least one SN 203. In particular, the dual connectivity system 200 in FIG. 2 includes one shown UE 201, one shown MN 202, and one shown SN 203 for illustrative purpose. Although a specific number of UEs 201, MNs 202, and SNs 203 are depicted in FIG. 2, it is contemplated that any number of UEs 201, MNs 202, and SNs 203 may be included in the wireless communication system 200.

Referring to FIG. 2, the UE 201 may connect to the MN 202 and the SN 203 via an interface, for example, Uu interface as specified in 3GPP standard documents. The MN 202 and the SN 203 may be connected with each other via a network interface, for example, Xn interface as specified in 3GPP standard documents. The MN 202 may be connected to the core network via a network interface (not shown in FIG. 2). The UE 201 may be configured to utilize resources provided by the MN 202 and the SN 203 to perform data transmission. Similar to the embodiments illustrated in view of FIG. 1, the UE 201 can be various remote devices.

The MN 202 refers to a RAN node that provides a control plane connection to the core network. In an embodiment of the present application, in the E-UTRA-NR DC (EN-DC) scenario, the MN 202 may be an eNB. In another embodiment of the present application, in the next generation E-UTRA-NR DC (NGEN-DC) scenario, the MN 202 may be a next generation (ng)-eNB. In yet another embodiment of the present application, in the NR-DC scenario or the NR-E-UTRA DC (NE-DC) scenario, the MN 202 may be a gNB. AN MN 202 may also be referred to as a master-NG-RAN (M-NG-RAN) node in some embodiments of the present application.

The SN 203 may refer to a RAN node without control plane connection to the core network but providing additional resources to the UE 201. In some embodiments of the present application, in the EN-DC scenario, the SN 203 may be an en-gNB. In some other embodiments of the present application, in the NR-DC scenario, the SN 203 may be an ng-eNB. In yet another embodiment of the present application, in the NR-DC scenario or the NGEN-DC scenario, the SN 203 may be a gNB. AN SN 203 may also be referred to as a secondary-NG-RAN (S-NG-RAN) node in some embodiments of the present application.

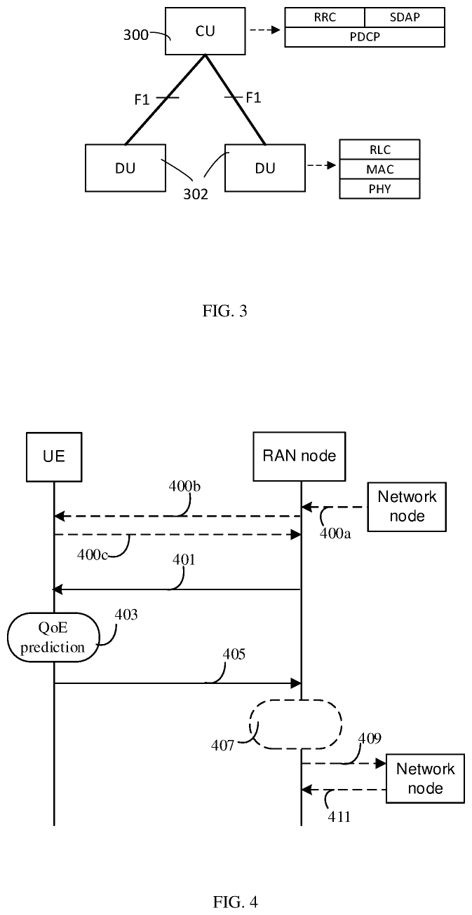

A RAN node, e.g., a BS can be split into multiple parts, each acting as a RAN node in some scenarios. FIG. 3 is a schematic diagram illustrating an internal structure of a RAN node, e.g., a BS according to some embodiments of the present application.

Referring to FIG. 3, in a split RAN architecture, the internal structure of a RAN node (e.g., BS 101 in FIG. 1 or MN 202 or SN 203 in FIG. 2) may be split into a central unit (CU) 300 and at least one distributed unit (DU) 302 (e.g., two DUs shown in FIG. 3). Although a specific number of DUs 302 are depicted in FIG. 3, it is contemplated that any number of DUs 302 may be included in the RAN node.

The CU 300 and DU 302 are connected with each other by an interface called F1 as specified in 3GPP standard documents. The RRC layer functionality, service data adaptation protocol (SDAP) functionality, and the packet data convergence protocol (PDCP) layer functionality are located in the CU 300. The radio link control (RLC) layer functionality, medium access control (MAC) layer functionality, and the physical (PHY) layer functionality are located in the DU 302.

According to some embodiments of the present application, the CU 300 may be further separated into a central unit control plane (CU CP or CU-CP) unit and at least one central unit user plane (CU UP or CU-UP) unit. The CU CP unit and each CU UP unit may be connected with each other by an interface called E1 as specified in 3GPP standard documents. The CU CP unit and the DU are connected by an interface called F1-C as specified in 3GPP documents. Each CU UP unit and the DU are connected by an interface called F1-U as specified in 3GPP standard documents.

When AI is introduced into 3GPP, AI based resource optimization becomes possible. For example, in Rel-18, 3GPP is going to specify mechanisms supporting AI assisted RAN optimization use cases, e.g., AI for QoE and slicing, wherein several issues need to be solved.

An exemplary issue to be solved is: if the AI model (or AI algorithm) for QoE prediction is deployed in the network side, e.g., in a RAN node, what are the required inputs of the AI model and how can the inputs be obtained.

Another exemplary issue to be solved is: if the AI model (or AI algorithm) for QoE prediction is deployed in the remote side, how can the RAN node obtain the QoE predicted by the UE, e.g., how can the predicted QoE be triggered and reported to the RAN node.

Yet another exemplary issue to be solved is: in mobility scenarios, e.g., handover, SN addition or change, how can the predicted QoE be transferred between relevant RAN nodes.

Yet another exemplary issue to be solved is: in view of the split RAN architecture, how can the predicted QoE be transferred between the CU and DU.

At least considering the above problems, embodiments of the present application provide a technical solution of supporting QoE prediction, which is based on an AI model in the network side or UE side.

For example, according to some embodiments of the present application, an exemplary method of supporting QoE prediction may include transmitting first information at least indicating one or more QoE metrics to a node, e.g., another RAN node or a UE, which may be performed by a RAN node (e.g., a serving gNB in non-mobility scenarios, or an SN in an SN addition or change procedure, or a target gNB in a handover procedure) or by a CN node or by an OAM system. The first information is a QoE history information request (or QoE history information configuration or historical QoE information request or historical QoE information configuration etc.) or QoE prediction configuration information (or QoE configuration information for prediction or predicted QoE configuration information or QoE prediction information request etc.). The exemplary method of supporting QoE prediction may further include receiving second information at least indicating the one or more QoE metrics and values of the one or more QoE metrics. The second information is a QoE history information report in response to the QoE history information request or a QoE prediction information report in response to the QoE prediction configuration information.

According to some embodiments of the present application, an exemplary method of supporting QoE prediction, which may be performed by a UE, may include: receiving first information at least indicating one or more QoE metrics from a RAN node (or a CU or CU-CP in the split RAN architecture), e.g., a serving gNB, or an SN in an SN addition or change procedure, or a target gNB in a handover procedure etc. The first information is a QoE history information request or QoE prediction configuration information. The exemplary method of supporting QoE prediction may further include transmitting second information at least indicating the one or more QoE metrics and values of the one or more QoE metrics, wherein the second information is a QoE history information report in response to the QoE history information request or a QoE prediction information report in response to the QoE prediction configuration information.

Hereafter, more specific embodiments of the present application will be illustrated in view of various scenarios.

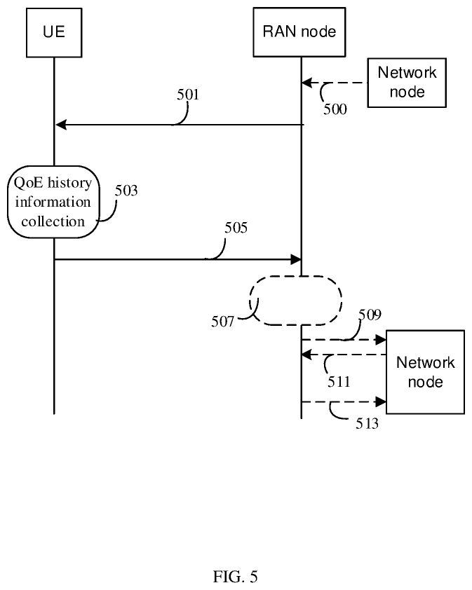

FIG. 4 is a flow chart illustrating an exemplary procedure of a method of supporting QoE prediction according to some embodiments of the present application. Although the method is illustrated in a system level by a RAN node in the network side and a UE in the remote side, persons skilled in the art should understand that the method implemented in the RAN node and UE can be separately implemented and/or incorporated by other apparatus with the like functions. The RAN node can be a gNB, or a CU or CU-CP of a gNB in the split RAN architecture or other node in the RAN. Dependent on different scenarios, the RAN node may be a serving gNB, a target gNB, or an SN etc.; or a CU or CU-CP of the serving gNB, the target gNB, or the SN etc. in the split RAN architecture. In addition, in embodiments illustrated in FIG. 4, the AI model (or AI algorithm) is deployed at least in the UE side.

Referring to FIG. 4, in step 401, the RAN node may send QoE prediction configuration information to the UE, e.g., by a RRC message. The QoE prediction configuration information can be initiated by the RAN node itself or by other network node (e.g., another RAN node (peer RAN node or DU in the split RAN architecture) or a CN node or OAM system).

For example, in some embodiments of the present application, the QoE prediction information reporting (or QoE prediction information collection) is activated in the RAN node, and it is initiated by the network node in step 400a. The network node will initiate the QoE prediction information collection by sending QoE prediction configuration information to the RAN node, e.g., by means of UE-associated signaling in the case of the network node being another RAN node or a CN node or by configurations in the case of the network node being an OAM system.

In the case that the network node is a CN node, e.g., an access and mobility management function (AMF), the UE-associated signaling may be an Initial Context Setup Request message during an initial context setup procedure, or in an UE Context Modification Request message during a UE context modification procedure, or in an Handover Required message during a handover preparation procedure, or in an Handover Request message during a handover resource allocation procedure.

In the case that the network node is a peer RAN node, the UE-associated signaling may be an Handover Request message during a handover preparation procedure (e.g., the RAN node is a target RAN node and the peer RAN node is a source RAN node), or an Retrieve UE Context Response message during a Retrieve UE Context procedure(e.g., the RAN node is a new RAN node or receiving RAN node and the peer RAN node is an old RAN node or last serving RAN node), or an SN Addition Request message during an SN addition preparation procedure (e.g., the RAN node is an SN and the peer RAN node is an MN), or an SN Modification Request message during an MN initiated SN modification preparation procedure (e.g., the RAN node is an SN and the peer RAN node is an MN).

In some other embodiments of the present application, before the RAN node sends the QoE prediction configuration information to the UE, the RAN node may determine whether the UE supports the QoE prediction, e.g., based on a QoE prediction capability report from the UE. The RAN node will transmit the QoE prediction configuration information only after receiving the QoE prediction capability report indicating that the UE is capable of predicting QoE. An exemplary QoE prediction capability report may include an indicator, which indicates whether QoE prediction is supported by the UE. For example, the indicator may be expressed by a BOOLEAN (e.g., true or false), or an ENUMERATED (e.g., supported), or by other methods.

The UE may report its QoE prediction capability, e.g., by a UE Capability Information message on its own initiative or in response to a QoE prediction capability request from the RAN node. For example, the RAN node may send a QoE prediction capability request, e.g., by a UE Capability Enquiry message to the UE in step 400b when the RAN node needs the QoE prediction capability information of the UE. After receiving the QoE prediction capability request from the RAN node, the UE will compile and send the QoE prediction capability report to the RAN node in step 400c, e.g., by a UE Capability Information message.

The QoE prediction configuration information at least indicates one or more QoE metrics (or QoE parameters). Each QoE metric and its value can be expressed in various manners.

An exemplary QoE metric is quality level of service, which is measured by performance of subjective tests between two nodes, e.g., between an application server and UE. In some embodiments of the present application, the quality level of the service is MOS, which provides a numerical indication of the perceived quality from the user's perspective of received service. For example, a value of the MOS is expressed as a single number in the range 1 to 5, wherein 1 is the lowest perceived quality, and 5 is the highest perceived quality, or vice versa. In addition to the MOS, the quality level of the service may be measured by other suitable methods.

Another exemplary QoE metric is application layer buffer level, which indicates a buffer level of application layer. For example, a value of the application layer buffer level being 1 corresponds to 10 ms, and a value of the application layer buffer level being 2 corresponds to 20 ms and so on. There may be a maximum value of the application layer buffer level, e.g., 30000 ms.

Yet another exemplary QoE metric is initial playout delay, which indicates an initial playout delay of application layer. Similar to application layer buffer level, a value of the initial playout delay being 1 corresponds to 1 ms, a value of the initial playout delay being 2 corresponds to 2 ms and so on. There may also be a maximum value of the initial playout delay, e.g., 30000 ms.

Yet another exemplary QoE metric is corruption duration, which indicates a time period from time of a last uncorrupted frame (good frame) before corruption (e.g., frame corruption) to time of a first subsequent uncorrupted frame after the corruption. Similarly, a value of the corruption duration 1 corresponds to 1 ms, a value of the corruption duration 2 corresponds to 2 ms and so on. There may also be a maximum value of the corruption duration, e.g., 30000 ms.

Yet another exemplary QoE metric is rendered viewports, which indicates a list of viewports that have been rendered during media presentation.

Yet another exemplary QoE metric is play period, which indicates a time interval between a user action and whichever occurs soonest among a next user action, end of playback or a failure that stops playback. Similarly, a value of the play period being 1 corresponds to 1 ms, a value of the play period being 2 corresponds to 2 ms and so on. There may also be a maximum value of the play period, e.g., 30000 ms.

Yet another exemplary QoE metric is comparable quality viewport switching latency, which indicates latency and quality-related factors when viewport movement causes quality degradations, e.g., when low-quality background content is briefly shown before the normal higher-quality is restored.

In some embodiments of the present application, the QoE prediction configuration information further indicates at least one other parameter besides the one or more QoE metrics.

For example, the QoE prediction configuration information further indicates an indicator which indicates whether QoE prediction information needs to be reported. For example, the QoE prediction configuration information is a RRC Reconfiguration message, which includes an indicator indicating whether the predicted QoE information should be provided by the UE. The indicator may be expressed by an integer, e.g., 1; or BOOLEAN, e.g., true or false; or ENUMERATED, e.g., prediction; or by other methods.

In another example, the QoE prediction configuration information further indicates an analytics period which indicates a time interval in the future that the predicted QoE information will be located. An exemplary time interval is expressed with start time (e.g., actual start time) and end time (e.g., actual end time), e.g., via universal time coordinated (UTC) time. In some embodiments of the present application, the time interval may be a specific time point, e.g., by setting the start time and end time to the same value.

In yet another example, the QoE prediction configuration information further indicates a trigger condition which indicates criteria of triggering QoE prediction information reporting. An exemplary trigger condition is a threshold, e.g., a best QoE metric value threshold, a worst QoE metric value threshold or an average QoE metric value threshold, which triggers the QoE prediction information reporting. Regarding the best QoE metric value threshold, it indicates the conditions on the level to be reached for the QoE prediction information reporting. For example, if the best MOS value threshold is 3 while the predicted MOS value is lower than 3, the UE will not report the predicted QoE information. Regarding the worst QoE metric value threshold, it indicates the conditions on the level below for the QoE prediction information reporting. For example, if the worst MOS value threshold is 2 and the predicted MOS value is lower than 2, the UE will report the predicted QoE information. Regarding the average QoE metric value threshold, it indicates the conditions on the level to be reached for the QoE prediction information reporting of all the predicted QoE information. For example, if the average MOS value threshold is 3 and the average value of the predicted MOS value is lower than 3, the UE will not report the QoE prediction information.

In yet another example, the QoE prediction configuration information further indicates a radio condition which indicates an environment under which QoE prediction information will be applied. An exemplary radio condition may be at least one of a cell identifier (ID), e.g., a physical cell identifier or a new radio cell global identifier, or reference signal receiving power (RSRP) or reference signal receiving quality (RSRQ).

In yet another example, the QoE prediction configuration information further indicates a preferred level of accuracy which indicates a preferred accuracy level of QoE prediction information. For example, the preferred level of accuracy may be expressed as: low, medium, high or highest.

In yet another example, the QoE prediction configuration information further indicates time information which indicates the latest time that QoE prediction information is expected to be received.

After receiving the QoE prediction configuration information, the UE will apply the QoE prediction configuration information and perform QoE prediction, e.g. by the deployed AI model (or AI algorithm) in step 403. For example, for the QoE prediction configuration information, the UE will:
if the access stratum (AS) layer has received, but not sent, QoE prediction information report from upper layers (e.g., upper than the AS layer); and if the QoE prediction information reporting has not been suspended, then set the value of QoE prediction information to the received value from the upper layer;
else, submit the QoE prediction information report to lower layers (e.g., a layer lower than the AS layer) for transmission upon which the QoE prediction procedure ends.

In step 405, the UE will send the QoE prediction information report to the RAN node, e.g., by a RRC message, which at least indicating the one or more QoE metrics and values of the one or more QoE metrics. In the case that there is a trigger condition(s) in the QoE prediction configuration information, the UE will report the predicted QoE information in response to the trigger condition being met. An exemplary of such RRC message is a MeasurementReportAppLayer message. In some embodiments of the present application, the QoE prediction information report may further include at least one other parameter and its value besides the one or more QoE metrics and values of the one or more QoE metrics.

For example, the QoE prediction information report may further include an indicator which indicates whether a QoE information report (or reported QoE information) is predicted. The indicator can be expressed by an integer (e.g., 1), or a BOOLEAN (e.g., true or false), or an ENUMERATED (e.g., prediction), or any other methods.

In another example, the QoE prediction information report may further include a radio condition which indicates an environment under which QoE prediction information will be applied. An exemplary radio condition may be at least one of a cell ID, e.g., a physical cell ID or a new radio cell global ID, or RSRP or RSRQ.

In yet another example, the QoE prediction information report may further include a time stamp of analytics generation which indicates when QoE prediction information was generated. The time stamp of analytics generation allows the RAN node to decide until when the received QoE prediction information will be used.

In yet another example, the QoE prediction information report may further include at least one of a validity period which indicates a time period for which QoE predication information is valid, or a confidence level which indicates probability assertion in QoE prediction.

After receiving the QoE prediction information report, the RAN node may perform various operations. For example, the RAN node may perform resource optimization, e.g., scheduling, resource allocation, based on the QoE prediction information report in step 407. In another example, the RAN node will generate another QoE prediction information report of the UE based on the QoE prediction information report, e.g., using the QoE prediction information report from the UE as inputs of the AI model (or AI algorithm) deployed in the RAN node in step 407. The format of the QoE prediction information report generated by the RAN node is identical or similar to that received from the UE, and thus will not be illustrated in detail.

In some embodiments of the present application, regardless of whether a QoE prediction information request is received from a network node, the RAN node may send the QoE prediction information report received from the UE or generated by itself to the network node in step 409. The network node can use the reported QoE prediction information for resource optimization, e.g., scheduling, resource allocation. Similar to the above, the network node can be another RAN node (a peer node or DU in the split RAN architecture), a CN node or an OAM system.

In the case that the network node is a peer RAN node, the QoE prediction information report can be sent from the RAN node to the peer RAN node over Xn or X2 interface. For example, the QoE prediction information report is included in a Handover Request message during a handover preparation procedure, or in a Retrieve UE Context Response message during a retrieve UE context procedure, or in an SN Addition Request message during an SN addition preparation procedure, or in an SN Modification Request message during an MN initiated SN modification preparation procedure.

In the case that the RAN node is a CU or CU-CP and the network node is a DU, the QoE prediction information report can be sent from the CU or CU-CP to the DU over F1 interface. For example, the QoE prediction information report is included in a QoE Information Transfer message during a QoE information transfer procedure.

In the case that the network node is a CN node, e.g., AMF, the QoE prediction information report can be sent from the RAN node to the CN node over next generation (NG) interface. For example, the QoE prediction information report is included in a Handover Required message during a handover preparation procedure.

In the case that the network node is an OAM system, the QoE prediction information report can be sent from the RAN node to the OAM system.

In some scenarios, the network node may send a QoE measurement report of the UE to the RAN node in response to receiving the QoE prediction information report, and the RAN node will receive it in step 411. The QoE measurement report contains at least QoE metric(s) and values of the QoE metric(s) measured by the UE. The RAN node can use the QoE measurement report to evaluate the accuracy of the AI model (or AI algorithm) for QoE prediction, and/or trigger further training the AI model or AI algorithm if necessary.

Similarly, in the case that the network node is a peer RAN node, the QoE measurement report can be sent from the peer RAN node to the RAN node over Xn or X2 interface. In the case that the RAN node is a CU or CU-CP and the network node is a DU, the QoE measurement report can be sent from the DU to the CU or CU-CP over F1 interface. In the case that the network node is a CN node, e.g., AMF, the QoE measurement report can be sent from the CN node to the RAN node over NG interface. In the case that the network node is an OAM system, the QoE measurement report can be provided by the OAM system, e.g., via configuration.

According to some other embodiments of the present application, no QoE prediction capability of UE is required, while QoE history information is required from the UE. For example, FIG. 5 is a flow chart illustrating another exemplary procedure of a method of supporting QoE prediction according to some other embodiments of the present application. Similar to FIG. 4, although the method is illustrated in a system level by a RAN node in the network side and a UE in the remote side, persons skilled in the art should understand that the method implemented in the RAN node and UE can be separately implemented and/or incorporated by other apparatus with the like functions. The RAN node can be a gNB, or a CU or CU-CP of a gNB in the split RAN architecture or other node in the RAN. Dependent on different scenarios, the RAN node may be a serving gNB, a target gNB, or an SN etc.; or a CU or CU-CP of the serving gNB, the target gNB, or the SN etc. in the split RAN architecture. In addition, in embodiments illustrated in FIG. 5, the AI model (or AI algorithm) is deployed at least in the network side, e.g., the RAN node or other network node.

Referring to FIG. 5, in step 501, the RAN node may send QoE history information request to the UE, e.g., by a RRC message. The QoE history information request can be initiated by the RAN node itself or by other network node (e.g., another RAN node (peer RAN node or DU in the split RAN architecture) or a CN node or OAM system).

For example, in some embodiments of the present application, the QoE history information request is activated in the RAN node, and it is initiated by the network node in step 500. The network node will send the QoE history information request to the RAN node, e.g., by means of UE-associated signaling in the case of the network node being another RAN node or a CN node or by configurations in the case of the network node being an OAM system. In some other embodiments of the present application, the RAN node may initiate the QoE history information request in response to QoE prediction configuration information from the network node. The QoE history information request or QoE prediction configuration information are transferred between the RAN node and network node by messages and interfaces similar to those illustrated above, and thus will not be further illustrated in detail.

The QoE history information request at least indicates one or more QoE metrics (or QoE parameters), which will not be repeated herein. In some embodiments of the present application, the QoE history information request may further indicate at least one other parameter besides the one or more QoE metrics.

For example, the QoE history information request further indicates an indicator which indicates whether QoE history information needs to be reported. For example, the QoE history information request is a UE Information Request message, which includes an indicator indicating whether the UE should report QoE history information. The indicator may be expressed by an integer, e.g., 1; or BOOLEAN, e.g., true or false; or ENUMERATED, e.g., history; or by other methods.

In another example, the QoE history information request further indicates a service type which indicates a type of the QoE history information to be collected. For example, a value “streaming” indicates QoE history information collection for streaming services, a value “mtsi” indicates QoE history information collection for multimedia telephony service for IP multimedia subsystem (MTSI), and a value “vr” indicates QoE history information collection for VR services.

In yet another example, the QoE history information request further indicates an area scope which indicates at least one object for which the QoE history information is required. The area scope may be a cell ID (e.g., physical cell ID or new radio cell global ID), or tracking area identity (TAI).

In yet another example, the QoE history information request further indicates a trigger condition which indicates criteria of triggering QoE history information reporting. An exemplary trigger condition is a threshold, e.g., a best QoE metric value threshold, a worst QoE metric value threshold or an average QoE metric value threshold, which triggers the QoE history information reporting. Regarding the best QoE metric value threshold, it indicates the conditions on the level to be reached for the QoE history information reporting. For example, if the best MOS value threshold is 3 while the best MOS value is lower than 3, the UE will not report the QoE history information. Regarding the worst QoE metric value threshold, it indicates the conditions on the level below for the QoE history information reporting. For example, if the worst MOS value threshold is 2 and the worst MOS value is lower than 2, the UE will report the QoE history information. Regarding the average QoE metric value threshold, it indicates the conditions on the level to be reached for the QoE history information reporting of all the logged QoE measurements. For example, if the average MOS value threshold is 3 and the average value of the MOS value is lower than 3, the UE will not report the QoE history information.

In yet another example, the QoE history information request further indicates time information which indicates latest time that the QoE history information is expected to be received.

After receiving the QoE history information request, the UE will collect the QoE history information and store the related information (it is supposed that the UE supports such information storage) in step 503. In some embodiments of the present application, the QoE history information can be stored as one or more entries of QoE measurement results (e.g., a list of QoE measurement results) that the UE has measured in a prior period. For example, the stored QoE history information may include at most 16 (or another number) entries of recently collected QoE measurement results, e.g., in time order. The most recently collected QoE measurement information is stored first in the list (or the first entry).

Each entry of QoE history information includes at least the QoE metric(s) and its measured value(s) within a configured valid area for a service type. In some embodiments of the present application, each entry further includes at least one other parameter besides the one or more QoE metrics and the values of the one or more QoE metrics.

For example, each entry may further include the start time and end time of QoE measurement indicated by application layer. An exemplary time interval is expressed with start time and end time, e.g., via UTC time during which the QoE measurement is performed by the application layer. In some embodiments of the present application, the time interval may be a specific time point, e.g., by setting the start time and end time to the same value.

In another example, each entry may further include a visited cell list of UE, and optionally may also include duration of the UE stay in each visited cell during the QoE measurement is performed.

In yet another example, each entry may further include a radio condition at timing that the values of the one or more QoE metrics are received from upper layer (e.g., a layer upper than the application layer). The radio condition indicates the environment under which the QoE metric value is collected or measured, e.g., by RSRP or RSRQ.

In yet another example, each entry may further include a time stamp that the values of the one or more QoE metrics are received from upper layer. The time stamp indicates when the QoE metric value was generated.

In view of different parameters and values to be collected and stored, in an exemplary QoE history information storage procedure, the UE will store an entry of QoE history information (possibly after removing the oldest entry, if necessary) and set the QoE metric value in the entry as the following, wherein the UE will:
if the service type is available, then set the service type to indicate the service type of QoE metric value;
if the QoE measurement time interval is available, then set the QoE measurement start time and end time during which the QoE measurement is performed; and
   if the visited cell list is available, then include an entry in visited cell list (possibly after removing the oldest entry, if necessary), according to following:
      if the new radio cell global identifier of the cell is available, then include the new radio cell global identifier of that cell;
      else, include the physical cell identifier of that cell; include the duration of stay in that cell during which the QoE measurement is performed;
if the radio condition is available, then set the radio condition to include the environment at the timing that QoE metric value is received from upper layer;
if the time stamp is available, then set the time stamp to indicate the time at which the QoE metric value was received;
set the QoE metric value to the received value from upper layer.

In step 505, the UE will send a QoE history information report to the RAN node, e.g., by a RRC message, based on the collected QoE history information. In the case that there is a trigger condition(s) in the QoE history information request, the UE will report the QoE history information in response to the trigger condition being met. An exemplary of such RRC message is a UE Information Response message. The QoE history information report may be identical or similar to the stored QoE history information as illustrated above, e.g., including a number of entry of QoE history information, and thus will not be repeated herein.

After receiving the QoE history information report, the RAN node may perform various operations in step 507. For example, the RAN node will generate a QoE prediction information report of the UE based on the QoE history information report, e.g., using the QoE history information from the UE as inputs of the AI model (or AI algorithm) deployed in the RAN node in step 507.

In some embodiments of the present application, regardless of whether a QoE prediction information request is received from a network node, the RAN node may send the QoE prediction information report generated by itself to the network node in step 509 as illustrated above. Similarly, the network node may send a QoE measurement report of the UE to the RAN node in response to receiving the QoE prediction information report, and the RAN node will receive it in step 511.

In some other embodiments of the present application, regardless of whether a QoE history information request is received from a network node, the RAN node may send the received QoE history information report to the network node in step 513, which is similar to the transmission of QoE prediction information report and will not be further illustrated in detail. The network node can use the received QoE history information report to perform QoE prediction for the UE by itself in some embodiments of the present application.

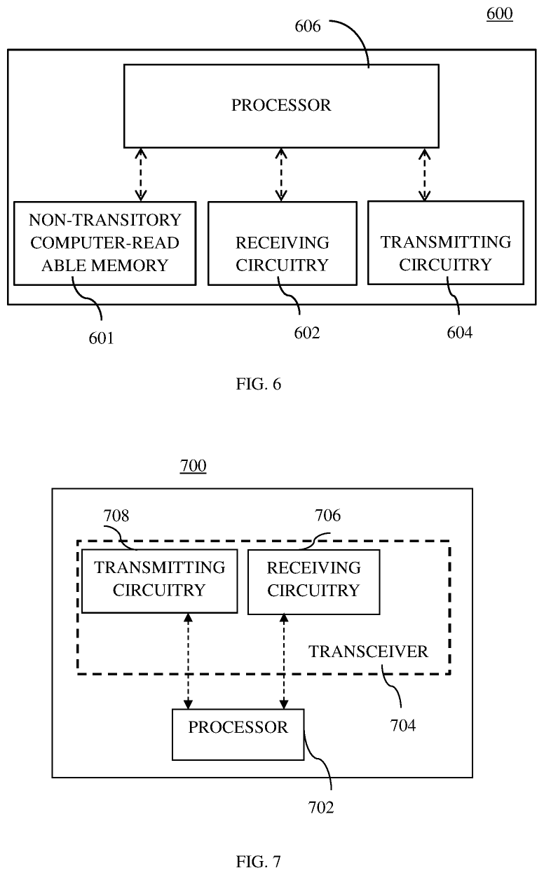

Besides methods of supporting QoE prediction, some embodiments of the present application also provide an apparatus of supporting QoE prediction. For example, FIG. 6 illustrates a block diagram of an apparatus of supporting QoE prediction 600 according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a CPU, a DSP, a microprocessor etc. The apparatus 600 may be a network node, e.g., RAN node, or CN node or an OAM system, or a UE configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to a remote apparatus, e.g., a UE as described above. For example, the computer-executable instructions, when executed, cause the processor 606 interacting with receiving circuitry 602 and transmitting circuitry 604, so as to perform the steps with respect to a remote apparatus as depicted above, e.g., shown in FIGS. 4 and 5.

In some embodiments of the present application, the non-transitory computer-readable medium 601 may have stored thereon computer-executable instructions to cause a processor to implement the method with respect to a RAN node, or CN node, or OAM system as described above. For example, the computer-executable instructions, when executed, cause the processor 606 interacting with receiving circuitry 602 and transmitting circuitry 604, so as to perform the steps with respect to a wireless communication apparatus or network node as depicted above, e.g., shown in FIGS. 4 and 5.

FIG. 7 is a block diagram of an apparatus of supporting QoE prediction 700 according to some other embodiments of the present application.

Referring to FIG. 7, the apparatus 700, for example a UE or a network node, e.g., a RAN node, or CN node or OAM system may include at least one processor 702 and at least one transceiver 704 coupled to the at least one processor 702. The transceiver 704 may include at least one separate receiving circuitry 706 and transmitting circuitry 708, or at least one integrated receiving circuitry 706 and transmitting circuitry 708. The at least one processor 702 may be a CPU, a DSP, a microprocessor etc.

According to some embodiments of the present application, when the apparatus 700 is a remote apparatus, e.g., a UE, the UE is configured to: receive first information at least indicating one or more QoE metrics from a RAN node, wherein the first information is a QoE history information request or QoE prediction configuration information; and transmit second information at least indicating the one or more QoE metrics and values of the one or more QoE metrics, wherein the second information is a QoE history information report in response to the QoE history information request or a QoE prediction information report in response to the QoE prediction configuration information.

According to some other embodiments of the present application, when the apparatus 700 is a network node, e.g., RAN node or CN or OAM system, the apparatus is configured to: transmit first information at least indicating one or more QoE metrics to a node, wherein the first information is a QoE history information request or QoE prediction configuration information; and receive second information at least indicating the one or more QoE metrics and values of the one or more QoE metrics, wherein the second information is a QoE history information report in response to the QoE history information request or a QoE prediction information report in response to the QoE prediction configuration information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A wireless communication apparatus, comprising:
at least one memory; and
at least one processor coupled with the at least one memory and configured to cause the wireless communication apparatus to:
transmit first information at least indicating one or more quality of experience (QoE) metrics to a node, wherein the first information is a QoE history information request or QoE prediction configuration information; and
receive second information at least indicating the one or more QoE metrics and values of the one or more QoE metrics, wherein the second information is a QoE history information report in response to the QoE history information request or a QoE prediction information report in response to the QoE prediction configuration information.

2. The wireless communication apparatus of claim 1, wherein the QoE history information request further indicates at least one of:
an indicator which indicates whether the QoE history information needs to be reported;
a service type which indicates a type of the QoE history information to be collected;
an area scope which indicates at least one object for which the QoE history information is required;
trigger condition which indicates criteria of triggering QoE history information reporting; and
time information which indicates latest time that the QoE history information is expected to be received.

3. The wireless communication apparatus of claim 1, wherein the QoE history information comprises one or more entries of QoE measurement results, and each entry includes at least one of the following parameters besides the one or more QoE metrics and the values of the one or more QoE metrics within a configured valid area for a service type:
start time and end time of QoE measurement indicated by application layer;
a visited cell list of user equipment (UE) and duration of UE stay in each visited cell during the QoE measurement is performed;
a radio condition at timing that the values of the one or more QoE metrics are received from upper layer; and
a time stamp that the values of the one or more QoE metrics are received from upper layer.

4. The wireless communication apparatus of claim 1, wherein the QoE prediction configuration information further indicates at least one of:
an indicator which indicates whether QoE prediction information needs to be reported;
time information which indicates latest time that QoE prediction information is expected to be received;
an analytics period which indicates a time interval in the future that QoE prediction information will be located;
a trigger condition which indicates criteria of triggering QoE prediction information reporting;
radio condition which indicates an environment under which QoE prediction information will be applied; and
a preferred level of accuracy which indicates a preferred accuracy level of QoE prediction information.

5. The wireless communication apparatus of claim 1, wherein the QoE prediction information report further comprises at least one of:
an indicator which indicates whether QoE information report is predicted;
a radio condition which indicates an environment under which QoE prediction information will be applied;
a time stamp of analytics generation which indicates when QoE prediction information was generated;
a validity period which indicates a time period for which QoE predication information is valid; and
a confidence level which indicates probability assertion in QoE prediction.

6. The wireless communication apparatus of claim 1, wherein the wireless communication apparatus is a radio access network (RAN) node, and the RAN node is configured to further generate QoE prediction information based on the second information.

7. The wireless communication apparatus of claim 1, wherein the wireless communication apparatus is a radio access network (RAN) node, the node is a user equipment (UE), and the RAN node is configured to receive a QoE prediction capability report from the UE.

8. The wireless communication apparatus of claim 1, wherein the wireless communication apparatus is a radio access network (RAN) node, and the first information is received from another RAN node, a core network (CN) node or an operation administration and maintenance (OAM) system.

9. A user equipment (UE), comprising:
at least one memory; and
at least one processor coupled with the at least one memory and configured to cause the UE to:
receive first information at least indicating one or more quality of experience (QoE) metrics from a radio access network (RAN) node, wherein the first information is a QoE history information request or QoE prediction configuration information; and
transmit second information at least indicating the one or more QoE metrics and values of the one or more QoE metrics, wherein the second information is a QoE history information report in response to the QoE history information request or a QoE prediction information report in response to the QoE prediction configuration information.

10. The UE of claim 9, wherein the QoE history information request further indicates at least one of:
an indicator which indicates whether the QoE history information needs to be reported;
a service type which indicates a type of the QoE history information to be collected;
an area scope which indicates at least one object for which the QoE history information is required;
trigger condition which indicates criteria of triggering QoE history information reporting; and
time information which indicates latest time that the QoE history information is expected to be received.

11. The UE of claim 9, wherein the QoE history information comprises one or more entries of QoE measurement results, and each entry includes at least one of the following parameters besides the one or more QoE metrics and the values of the one or more QoE metrics within a configured valid area for a service type:
start time and end time of QoE measurement indicated by application layer;
a visited cell list of UE and duration of UE stay in each visited cell during the QoE measurement is performed;
a radio condition at timing that the values of the one or more QoE metrics are received from upper layer; and
a time stamp that the values of the one or more QoE metrics are received from upper layer.

12. The UE of claim 9, wherein the QoE prediction configuration information further indicates at least one of:
an indicator which indicates whether QoE prediction information needs to be reported;
time information which indicates latest time that QoE prediction information is expected to be received;
an analytics period which indicates a time interval in the future that the QoE prediction information will be located;
a trigger condition which indicates criteria of triggering QoE prediction information reporting;
a radio condition which indicates an environment under which QoE prediction information will be applied; and
preferred level of accuracy which indicates a preferred accuracy level of QoE prediction information.

13. The UE of claim 9, wherein, the QoE prediction information report further comprises at least one of:
an indicator which indicates whether QoE information report is predicted;
a radio condition which indicates an environment under which QoE prediction information will be applied;
a time stamp of analytics generation which indicates when QoE prediction information was generated;
a validity period which indicates a time period for which QoE predication information is valid; and
a confidence level which indicates probability assertion in QoE prediction.

14. The UE of claim 9, wherein the at least one processor is configured to cause the UE to transmit a QoE prediction capability report to the RAN node.

15. A method performed by a user equipment (UE), the method comprising:
receiving first information at least indicating one or more quality of experience (QoE) metrics to a node, wherein the first information is a QoE history information request or QoE prediction configuration information; and
transmitting second information at least indicating the one or more QoE metrics and values of the one or more QoE metrics, wherein the second information is a QoE history information report in response to the QoE history information request or a prediction information report in response to the QoE prediction configuration information.

16. A processor for wireless communication, comprising:
at least one controller coupled with at least one memory and configured to cause the processor to:
receive first information at least indicating one or more quality of experience (QoE) metrics from a radio access network (RAN) node, wherein the first information is a QoE history information request or QoE prediction configuration information; and
transmit second information at least indicating the one or more QoE metrics and values of the one or more QoE metrics, wherein the second information is a QE history information report in response to the QoE history information request or a QoE prediction information report in response to the QoE prediction configuration information.

17. The processor of claim 16, wherein the QoE history information request further indicates at least one of:
an indicator which indicates whether the QoE history information needs to be reported;
a service type which indicates a type of the QoE history information to be collected;
an area scope which indicates at least one object for which the QoE history information is required;
a trigger condition which indicates criteria of triggering QoE history information reporting; and
time information which indicates latest time that the QoE history information is expected to be received.

18. The processor of claim 16, wherein the QoE history information comprises one or more entries of QoE measurement results, and each entry includes at least one of the following parameters besides the one or more QoE metrics and the values of the one or more QoE metrics within a configured valid area for a service type:
start time and end time of QoE measurement indicated by application layer;
a visited cell list of UE and duration of UE stay in each visited cell during the QoE measurement is performed;
a radio condition at timing that the values of the one or more QoE metrics are received from upper layer; and
a time stamp that the values of the one or more QoE metrics are received from upper layer.

19. The processor of claim 16, wherein the QoE prediction configuration information further indicates at least one of:
an indicator which indicates whether QoE prediction information needs to be reported;
time information which indicates latest time that QoE prediction information is expected to be received;
an analytics period which indicates a time interval in the future that the QoE prediction information will be located;
a trigger condition which indicates criteria of triggering QoE prediction information reporting;
a radio condition which indicates an environment under which QoE prediction information will be applied; and
a preferred level of accuracy which indicates a preferred accuracy level of QoE prediction information.

20. The processor of claim 16, wherein the QoE prediction information report further comprises at least one of:
an indicator which indicates whether QoE information report is predicted;
a radio condition which indicates an environment under which QoE prediction information will be applied;
a time stamp of analytics generation which indicates when QoE prediction information was generated;
a validity period which indicates a time period for which QoE predication information is valid; and
a confidence level which indicates probability assertion in QoE prediction.
